(19) United States
(12) Patent Application Publication
(10) Pub. No.: US 2005/0138263 A1
(43) Pub. Date: Jun. 23, 2005

(54) Method and apparatus to retain system control when a buffer overflow attack occurs

(76) Inventor: Francis X. McKeen, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,667

(22) Filed: Dec. 23, 2003

(51) Int. Cl. G06F 12/00

(52) U.S. Cl. 711/1

(57) ABSTRACT

A function call is executed during execution of a program. In response, a return address of the call is saved in a first stack and in a second stack, allocated by the operating system. After the called function is executed, the return addresses stored in the first and second stack are compared to determine if they match.

### FIELD OF THE INVENTION

This invention relates to computer system security. In particular, the invention relates to buffer overflow attacks that are used to take control of a computer system.

### BACKGROUND

Many computer systems today are vulnerable to attack using a technique known as a buffer overflow attack and more colloquially as “stack smashing.”

A stack is an area of memory that is dynamically assigned to a program by an operating system and comprises a number of contiguous memory locations to which data/variables required by the program may be written.

Programs today are written in a form in which reusable portions of code are identified with a function name that may be called from any location within the program by a function call instruction that identifies the function being called. Generally, when a function is called (hereinafter, the “called function”), the processor saves the return address at which program execution is to resume after execution of the called function on the stack. Thereafter, the operating system saves many of the variables/data required by the called function on the stack. For this purpose, the operating system allocates a stack frame or buffer within the stack to hold the data/variables.

FIG. 1 shows an example of a stack 100 wherein a buffer 104 comprising only four memory locations has been allocated. If, in this case, the data being written to the buffer 104 requires more than four memory locations, then the buffer 104 will be overwritten. This results in a return address 102 being overwritten.

In the case of a buffer overflow attack, a programmer can take control of a computer system by writing data 202 (see FIG. 2) into a variable called buffer 104 to cause the buffer 104 to overflow as a result of which the return address 102 is overwritten with a pointer 200 to virus code. Thus, upon completion of the called function, the program will resume execution at the address indicated by the pointer 200 to the virus code, resulting in virus code 204 being executed.

### BRIEF DESCRIPTION OF THE DRAWINGS

FIG. 1 shows a block diagram of a stack for a program before buffer overflow;

FIG. 2 shows a block diagram for a stack for the program after buffer overflow;

FIG. 3 shows a block diagram of hardware in accordance with one embodiment of the invention;

FIG. 4 shows a flowchart of processes performed in accordance with one embodiment; and

FIG. 5 shows a block diagram of dual stacks in accordance with one embodiment of the invention.

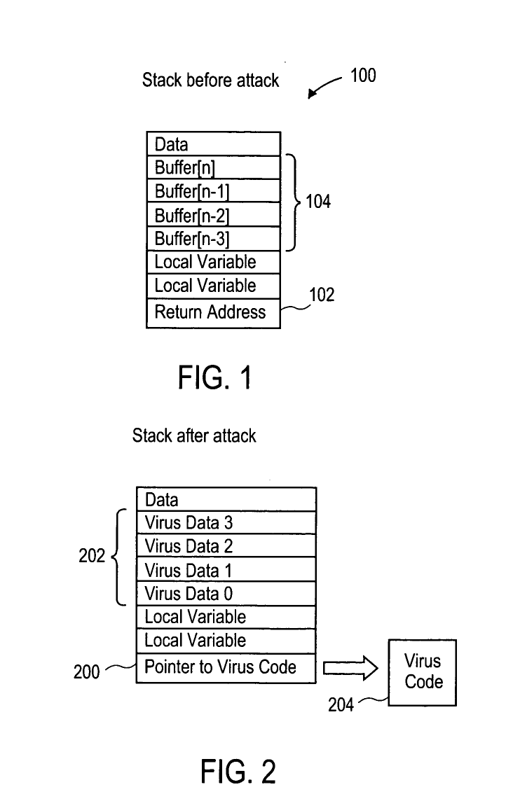

### DETAILED DESCRIPTION

A method and system to retain system control when a buffer overflow attack occurs, is described. In one embodiment, a function call is executed during execution of a program. In response, the processor saves a return address in a first stack and in a second stack. After the called function is executed, the return addresses stored in the first and second stack are compared to determine if they match.

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

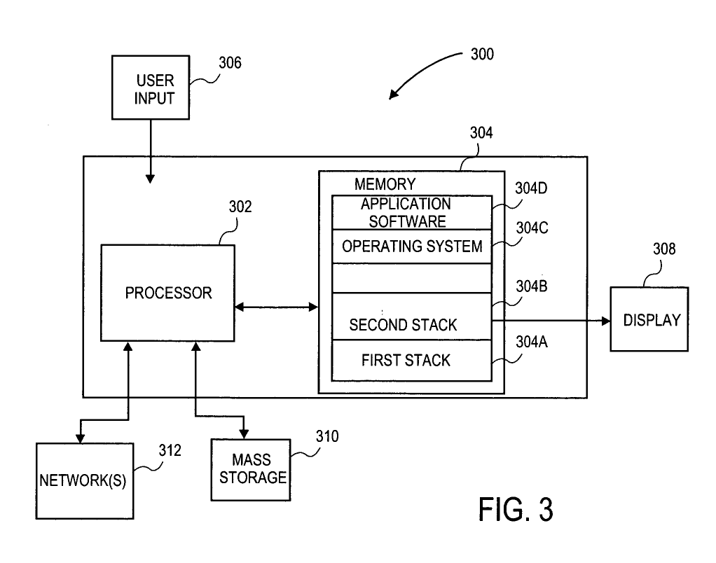

Referring to FIG. 3 of the drawings, reference numeral 300 generally indicates hardware representative of a system in accordance with embodiments of the invention. The hardware 300 typically includes at least one processor 302 coupled to a memory 304. The processor 302 may represent one or more processors (e.g. microprocessors), and the memory 304 may represent random access memory (RAM) devices comprising a main storage of the hardware 300, as well as any supplemental levels of memory e.g., cache memories, non-volatile or back-up memories (e.g. programmable or flash memories), read-only memories, etc. In addition, the memory 304 may be considered to include memory storage physically located elsewhere in the hardware 300, e.g. cache memory in the processor 302, as well as any storage capacity used as a virtual memory, e.g., as stored on a mass storage device 310. In one embodiment, the memory 304 can conveniently be thought of as having areas 304A-304D. The areas 304A and 304B are areas of the memory 304 corresponding to where a first stack and a second stack, respectively, are stored. The area 304C contains an operating system for the hardware 300, and the area 304D contains application software.

The hardware 300 also typically receives a number of inputs and outputs for communicating information externally. For interface with a user or operator, the hardware 300 may include one or more user input devices 306 (e.g., a keyboard, a stylus and digitizer, etc.) and a display 308 (e.g., a liquid crystal display (LCD) panel).

For additional storage, the hardware 300 may also include one or more mass storage devices 310, e.g., a disk drive such as a Compact Flash device. Furthermore, the hardware 300 may include an interface with one or more networks 312 (e.g., a local area network (LAN), a wide area network (WAN), a wireless network, and/or the Internet among others) to permit the communication of information with other computers coupled to the networks.

The hardware 300 operates under the control of the operating system 304D that executes various computer software applications, components, programs, objects, modules, etc.

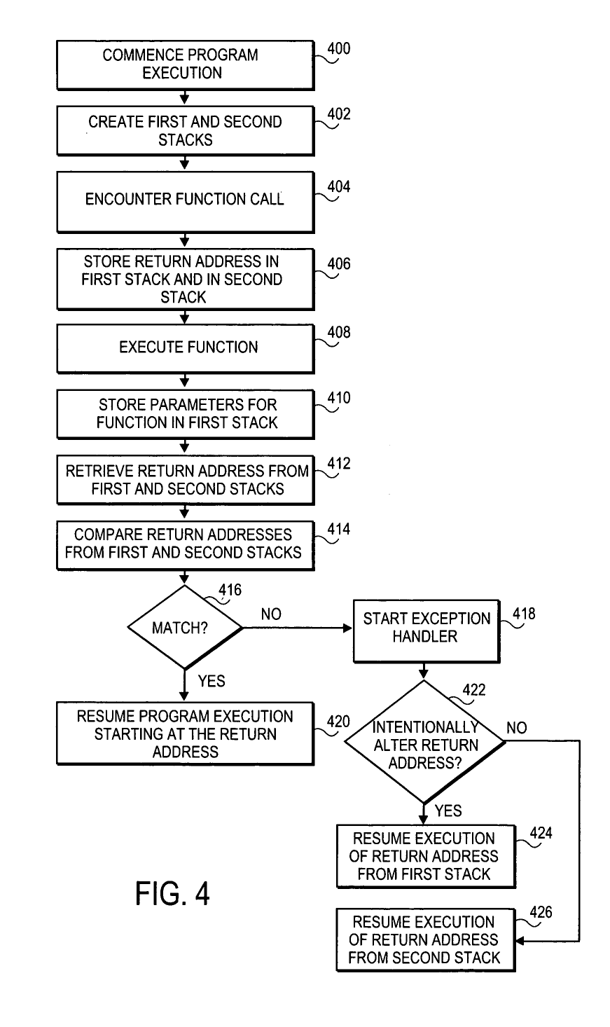

Referring now to FIG. 4 of the drawings, operations performed by the hardware 300 of FIG. 3, in accordance with one embodiment are shown. At 400, execution of a software program commences. At 402, the operating system 304D creates the first stack 304A, and the second stack 304B. At 404, the processor 302 encounters a function call. At block 406, in one embodiment, the return address, identifying where the program is to resume execution after execution of the called function, is stored in the first stack 304A, as well as in the second stack 304B. Thus, there are two copies of the return address, one copy in the first stack 304A, and the other copy in the second stack 304B.

In one embodiment, pointers to the first and second stacks are initially stored in an area of memory reserved by the operating system (OS) for storing task states. For example, in the case of X86 Intel Architecture, the pointers are stored in the Task State Segment (TSS). In one embodiment, when the stacks allocated by the OS are in use, the pointer to the stack is loaded in a register of the processor. In one embodiment, the program being executed is restricted from accessing the second stack, or any other stack that is exclusively being used to store return addresses.

In addition, in one embodiment the process for saving the return address may vary based upon the type of function call. In the case of a near call (a call that transfers execution of the program to a section of code that is within a predefined proximity of the call function), the instruction pointer of the function call is pushed on the first stack 304a and the second stack 304b. For X86 Architecture, the extended instruction pointer (EIP) is pushed onto the stacks.

In the case of a far call (a call that transfers execution of the program to a section of code that is beyond a predefined proximity of the call), the instruction pointer of the function call and the code segment (CS) are pushed on the first stack 304a and the second stack 304b. In the case of an inter-privilege call, a new pair of stacks is used, which correspond to the privilege level of the inter-privilege call. The new pair of stacks corresponding to the privilege level of the inter-privilege call is used in the same manner as described above with respect to the first stack 304a and the second stack 304b. The pointers to the new pair of stacks are obtained from the TSS and read into one or more registers of the processor.

Furthermore, in the case of task switch, again, a new pair of stacks is used, which correspond to the task of the task switch. The new pair of stacks corresponding to the task of the task switch is used in the same manner as described above with respect to the first stack 304a and the second stack 304b.

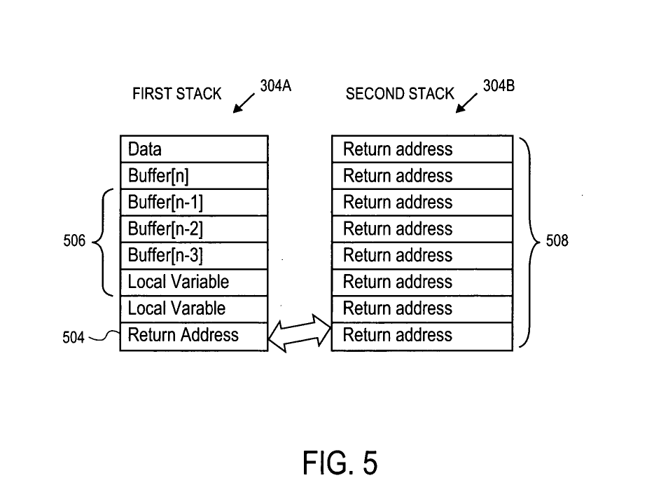

Referring again to FIG. 4 of the drawings, at block 408, the hardware 300 executes the called function. At block 410, parameters and/or data variables used for execution of the called function are also stored in the first stack 304A. Embodiments of first stack 304A and the second stack 304B as shown in FIG. 5 of the drawings. As illustrated in FIG. 5, the first stack 304A contains a return address 504, as well as a buffer 506 which is used to store parameters and/or data variables for the called function. The second stack 304B contains a return addresses 508 associated with various function calls.

At block 412, a return instruction of the function, at or near the end of the function, is executed to retrieve the return address of the call from the second stack 304B and the first stack 304A. In one embodiment, the return instruction performs the operations of popping the top entry of the first stack 304a and the first entry of the second stack 304b (or alternatively the third stack in the case of an inter-privilege call or task switch). Thereafter, at 414, the return addresses from the first and second stacks 304A, 304B are compared.

If, at block 416, the return addresses match, then block 420 is executed, wherein program execution is resumed starting at the return address. If, however, at 416 it is determined that the return addresses from the first and second stacks do not match, then at block 418, the return instruction invokes an exception to call an exception handler to determine whether execution of the program is to continue or whether an alternative form of corrective measure is necessary (e.g., whether an anti-virus response is appropriate). (not shown).

In one embodiment, the return instruction reports the instruction pointer of the return address which encountered the problem. In one embodiment, the exception saves return address values from the first and second stacks that did not match.

In block 422, the exception handler determines whether the return address retrieved from the first stack was intentionally altered (i.e., written over) by the program being executed. While this would typically be considered a violation of software operations, the presence of a large legacy base of this behavior does exist. In one embodiment, the operating system (or some alternative logic) may cache the instruction pointers of the function calls which are expected to alter their respective return addresses. The exception handler would then read the cache to determine if the current function call which has produced the current exception is identified in the cache.

If the modified return address from the first stack 304a is determined to have been intentionally modified by the program, in block 424 the exception handler has the execution of the program resume at the modified return address. If the modified return address from the first stack 304a is determined to have not been intentionally modified by the program, in block 426 the exception handler has the execution of the program resume at the return address of the second stack 304a, which represents the original return address of the function call. Alternatively, the handler can force the program to terminate execution.

Although the present invention has been described with reference to specific exemplary embodiments, it will be evident that the various modification and changes can be made to these embodiments without departing from the broader spirit of the invention as set forth in the claims. Accordingly, the specification and drawings are to be regarded in an illustrative sense rather than in a restrictive sense.

For example, in one embodiment, the first stack 304A may only store parameters and/or data variables used for execution of the called function, and not include return addresses. The second stack 304B would store the return address of the called function. In this case, the return address is taken from the second stack.

In general, the routines executed to implement the embodiments of the invention, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of signal bearing media used to actually effect the distribution. Examples of signal bearing media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. A method, comprising:
executing a function call during a program execution;
saving a return address in a first stack and in a second stack allocated by an operating system;
executing a return instruction; and
determining if the return address stored in the first stack matches the return address stored in the second stack.

2. The method of claim 1, wherein when the function call is a near call, an instruction pointer is pushed onto the second stack.

3. The method of claim 2, wherein when the function call is a far call, an instruction pointer and a code segment is pushed onto the second stack.

4. The method of claim 3, wherein when the call is an inter-privilege call, saving a return address for the inter-privilege call on a third stack corresponding to a privilege level of the inter-privilege call.

5. The method of claim 3, wherein when the call is a task switch, saving a return address for the task switch call on a third stack corresponding to a task of the task call.

6. The method of claim 1, further including executing a return instruction to determine if the return address stored in the first stack matches the return address stored in the second stack, wherein execution of the return instruction includes popping a top entry from the first and second stacks and comparing contents of the first and second stacks.

7. The method of claim 6, further including the return instruction invoking an exception handler, in response to the return address of the first stack not matching the return address of the second stack, the exception handler determining whether to return program execution to the return address of the first stack or to the return address of the second stack.

8. The method of claim 7, wherein the first stack includes data variables and return addresses, and the second stack includes only return addresses.

9. The method of claim 8, further including restricting the program in execution from accessing the second stack.

10. The method of claim 7, further including the exception handler determining if the program execution intentionally modified the return address of the first stack.

11. The method of claim 11, further including, in response to the return address of the first and second stack not matching, pushing the return address of the first stack onto the first stack and pushing the return address of the second stack onto the second stack.

12. A method, comprising:
executing a function call instruction during a program execution;
saving a return address in a first stack allocated by an operating system, wherein the first stack only includes one or more return addresses;
executing a function of the function call;
saving, in a second stack at least one of parameters and data variables used for execution of the function, wherein the second stack does not include a return address.

13. The method of claim 12, wherein when the call is a near call, an instruction pointer is pushed onto the first stack.

14. The method of claim 13 wherein when the call is a far call, an instruction pointer and a code segment is pushed onto the first stack.

15. The method of claim 14, wherein when the call is an inter-privilege call, saving a return address for the inter-privilege call on a third stack corresponding to a privilege level of the inter-privilege call.

16. The method of claim 14, wherein when the call is a task switch call, saving a return address for the task switch call on a third stack corresponding to a task of the task call.

17. A machine readable medium having stored thereon a set of instructions which when executed cause a system to perform a method comprising of:
executing a function call during a program execution;
saving a return address in a first stack and in a second stack allocated by an operating system;
executing a return instruction; and
determining if the return address stored in the first stack matches the return address stored in the second stack.

18. The machine readable medium of claim 17, wherein when the function call is a near call, an instruction pointer is pushed onto the second stack.

19. The machine readable medium of claim 18, wherein when the function call is a far call, an instruction pointer and a code segment is pushed onto the second stack.

20. The machine readable medium of claim 19, wherein when the call is an inter-privilege call, saving a return address for the inter-privilege call on a third stack corresponding to a privilege level of the inter-privilege call.

21. The machine readable medium of claim 19, wherein when the call is a task switch, saving a return address for the task switch call on a third stack corresponding to a task of the task call.

22. The machine readable medium of claim 17, further including the return instruction invoking an exception handler, in response to the return address of the first stack not matching the return address of the second stack, the exception handler determining whether to return program execution to the return address of the first stack or to the return address of the second stack.

23. The machine readable medium of claim 22, wherein the first stack includes data variables and return addresses, and the second stack includes only return addresses.

24. A system, comprising:
a processor;
a network interface; and
a machine readable medium having stored thereon a set of instructions which when executed cause a system to perform a method comprising of:
executing a function call during a program execution;
saving a return address in a first stack and in a second stack allocated by an operating system;
executing a return instruction; and
determining if the return address stored in the first stack matches the return address stored in the second stack.

25. The system of claim 24, wherein when the function call is a far call, an instruction pointer and a code segment is pushed onto the second stack.

26. The system of claim 25, wherein when the call is an inter-privilege call, saving a return address for the inter-privilege call on a third stack corresponding to a privilege level of the inter-privilege call.

27. The system of claim 25, wherein when the call is a task switch, saving a return address for the task switch call on a third stack corresponding to a task of the task call.

28. A machine readable medium having stored thereon a set of instructions which when executed cause a system to perform a method comprising of:
executing a function call during a program execution;
saving a return address in a first stack allocated by an operating system, wherein the first stack only includes one or more return addresses;
executing a function of the function call;
saving, in a second stack at least one of parameters and data variables used for execution of the called function, wherein the second stack does not include a return address.

29. The machine readable medium of claim 28, wherein when the call is an inter-privilege call, saving a return address for the inter-privilege call on a third stack corresponding to a privilege level of the inter-privilege call.

30. The machine readable medium of claim 28, wherein when the call is a task switch call, saving a return address for the task switch call on a third stack corresponding to a task of the task call.
